(19) United States
(12) Patent Application Publication
(10) Pub. No.: US 2004/0075221 A1
(43) Pub. Date: Apr. 22, 2004

(54) Inlet flange and seal for a collapsible filter element

(76) Inventors: Moshe Gershenson, Mohegan Lake, NY (US); John Pulek, Cheshire, CT (US); Mahesh Patel, Plantsville, CT (US)

Correspondence Address: Stephen M. Chin,Esq., REED SMITH LLP, 599 Lexington Avenue, New York, NY, 10022, US

(21) Appl. No.: 10/642,357

(22) Filed: Aug. 15, 2003

Related U.S. Application Data
(60) Provisional application No. 60/404,111, filed on Aug. 15, 2002.

(51) Int. Cl. F16J 15/46

(52) U.S. Cl. 277/628

(57) ABSTRACT

A filter system having a filter bag in a housing. The filter bag is attached to an inlet flange. The inlet flange has a lip portion located at its edges that rest upon the housing and will contact a lid covering the housing. The lip portion will have an elastomer seal located at the places where it contacts the housing and lid respectively. The elastomer seal is overmolded onto the inlet flange to be an integral part of the inlet flange. A portion of the seal extends from the inlet flange in the direction of the housing. That portion is parallel and in contact with the lid.

This application claims the benefits of U.S. provisional application Serial No. 60/404,111 filed Aug. 15, 2002.

### BACKGROUND

A) Field of Invention

This invention relates to a sealing apparatus for use with a filtration system and more particularly an elastomer seal for use with a flexible filter element in an enclosable housing.

B) Description of the Related Art

Bag filter systems typically consist of flexible filter bags placed in a housing. The housing can be cylindrical and consist of two basic components, the lid and the sump. The filter bags will have an open upper end and a closed bottom end. The filter bags can be cylindrical with the walls and bottom comprising of a filter media. Liquids or other substances to be filtered are received into the filter bag through the open end and are filtered through the filter media to exit the bag. After being filtered through the bag, the filtered liquids will either collect in the housing or exit the housing through conduits in the bottom of the housing.

To support the filter bag in the housing, the filter bag is usually attached to an inlet flange (also sometimes referred to as a “ring” or support ring). The inlet flange is typically composed of a rigid material such as polypropylene or polyester. The inlet flange will rest on the edges of an internal surface in the housing sump and is sized to fit the opening of the housing. The filter bag hangs from the inlet flange inside the housing and the inlet flange will have a hole or other conduits to ensure that the liquid to be filtered will pass through the filter bag. The material of the filter bag can be secured to the inlet flange in a variety of ways. Some examples include adhesives, stitching or welding, such as ultrasonic welding. A lid is securely covered on the housing to create an enclosed filter system, capable of causing the liquid to be filtered to flow under pressure higher than atmospheric pressure.

It is important that the inlet flange covers the entire opening of the housing to ensure that the unfiltered liquids do not bypass the filter bag and commingle with the filtered liquids in the housing. In particular, spaces between the lid and the inlet flange, as well as spaces between the inlet flange and the housing, can result in leaking of unfiltered liquids.

Various prior art devices design the inlet flange so that the lid of the housing will press against the inlet flange when covering the housing. That added pressure will compress the inlet flange to create a seal between the inlet flange and the lid. Some designs, such as the design in U.S. Pat. No. 5,075,004, also structure the lip of the inlet flange such that the internal pressure in the housing created by the volume of liquid entering the filter system will be added to the pressure created by the lid.

These designs may minimize the leakage, but rarely can prevent the leakage. The inlet flange and the lid are composed of rigid materials and are consequently more resistant to pressure. In addition, the plastic inlet flange can be subject to compression set or creep, especially at high temperatures. Thus, these designs should not be considered to create a dependable seal.

Other prior art designs provide a separate sealing gasket made of softer material inserted between the inlet flange and the closed lid. These designs can be subject to leakage due to misalignment of the sealing gasket between the lid and the inlet flange when placing the gasket on the inlet flange. Such misalignment can also be caused by the effects of internal pressure in the housing that can force the sealing gasket to shift out of position between the lid and inlet flange. In addition, separately manufacturing a sealing gasket and assembling it within a filter system increases costs.

Therefore, it is an object of this invention to provide an improved filter mechanism to prevent leakage of unfiltered liquids. It is a further object of this invention to provide an improved filter mechanism that will be less vulnerable to user error and more cost effective.

### SUMMARY OF THE INVENTION

The current invention involves a system that provides a sealing mechanism to prevent the leakage of unfiltered liquids to commingle with the filtered liquids. According to one aspect of the invention, there is an inlet flange provided to support a filter bag in a housing. The inlet flange has a lip that rests on a surface of the housing and a portion of the lip contacts the lid of the housing. An elastomer material is located at the areas where the lip contacts the housing and the lid of the housing. The elastomer material is molded to be an integral part of the lip of the inlet flange at those locations. When the lid is securely closed onto the housing, the lid contacts the elastomer material to create a positive seal between the inlet flange and the lid and between the inlet flange and the housing.

According to another aspect of the invention, the lip of the inlet flange has elastomer material at the locations where the lip contacts the housing and the lid. A portion of the elastomer material, however, extends away from the lip of the inlet flange in the direction of the interior of the housing and generally parallel to the plane of the lid of the housing. This portion may be in contact with the lid, but not located in-between the lid and the inlet flange when the lid is closed on the housing. This extended portion will create a positive seal due to the internal pressure in the housing.

According to yet another aspect of the invention, the lip of the inlet flange extends and is interposed between the housing and the lid in the areas where the housing and the lid would contact. An elastomer material is integrally molded to the lip of the inlet flange in those areas to create a positive seal with both the lid and the housing.

### BRIEF DESCRIPTION OF THE DRAWINGS

The accompanying drawings are included to provide an understanding of the invention and constitute a part of the specification.

FIG. 1 depicts a filter system that implements one embodiment of the present invention;

FIG. 2 is a perspective view of one embodiment depicting the present invention;

FIG. 3 is a cross sectional view showing the ends of the inlet flange in accordance with one embodiment of the present invention;

FIG. 4 is a cross sectional view showing the ends of the inlet flange in accordance with another embodiment of the present invention;

FIG. 5 is a cross sectional view showing the ends of the inlet flange in accordance with another embodiment of the present invention;

FIG. 6 is a cross sectional view showing the ends of the inlet flange in accordance with another embodiment of the present invention;

FIG. 7 is a cross sectional view showing the ends of the inlet flange in accordance with another embodiment of the present invention;

FIG. 8 is a cross sectional view showing the ends of the inlet flange in accordance with another embodiment of the present invention; and

FIG. 9 is a cross sectional view showing the ends of the inlet flange in accordance with another embodiment of the present invention.

### DESCRIPTION OF THE INVENTION

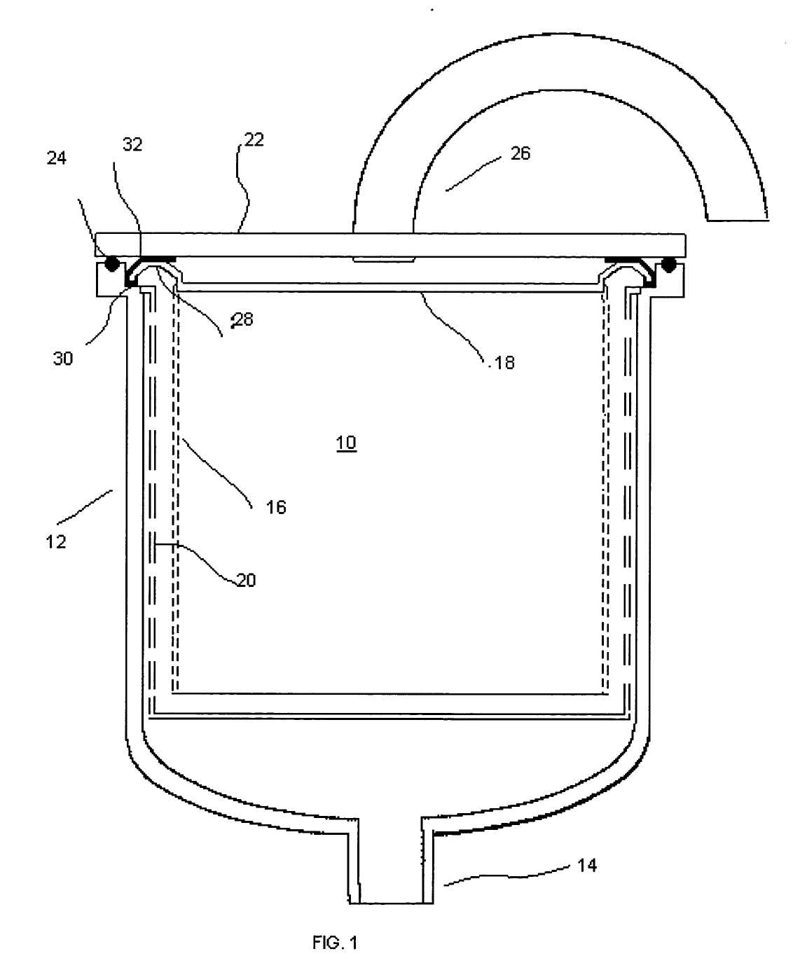

FIG. 1 depicts a filter system that utilizes one embodiment of the present invention. Filter system 10 is provided with cylindrical housing 12. Typically, cylindrical housing 12 is made of metal or other hard, durable material.

At one end, housing 12 has an outlet conduit 14 to allow liquids to leave the housing. The housing 12 is open at the other end. While depicted as cylindrical in shape and having one outlet, the size and shape of housing 12 and its inlets and outlets can vary.

Filter bag 16 extends into the housing 12 and is affixed to inlet flange 18. Filter bag 16 can be composed of any suitable permeable material depending on the filtering needs. Filter bag 16 can be ultrasonically welded to inlet flange 18 or affixed by various other methods to ensure that filter 16 bag is securely attached and that there are no spaces between the bag and the inlet flange 18.

Inlet flange 18 is molded out of polypropylene or a polyester type rigid material. Inlet flange 18 is sized to fit the entire opening of housing 12. The ends of the inlet flange 18 will have a lip 28 that contacts an internal surface edge 30 of the housing 12 to be supported in the housing 12. An elastomer material 32 is located at those points of contact. Inlet flange 18 will have one or more holes in it to allow liquids to enter filter bag 16.

Basket 20 can also be placed in housing 12 such that filter bag 16 will extend into basket 20. Basket 20 typically does not act as a filter element, but can provide additional support for filter bag 16 and serve as a buffer between the walls of housing 12 and filter bag 16. Similar to housing 12, basket 20 is composed of a hard durable material. Basket 20 has numerous holes or openings to allow for the filtered liquids to empty into the housing 12.

Filter system 10 also has a housing lid 22 that covers the opening of housing 12. Lid 22 is secured to housing 12 by mechanisms not shown, but are well known to those skilled in the art. An O-ring sealing gasket 24 is usually placed in-between the lid 22 and housing 12 at the point of contact between the two. Lid 22 will have an inlet conduit 26 to direct liquids entering the filter system 10 through lid 22 to the filter bag 16.

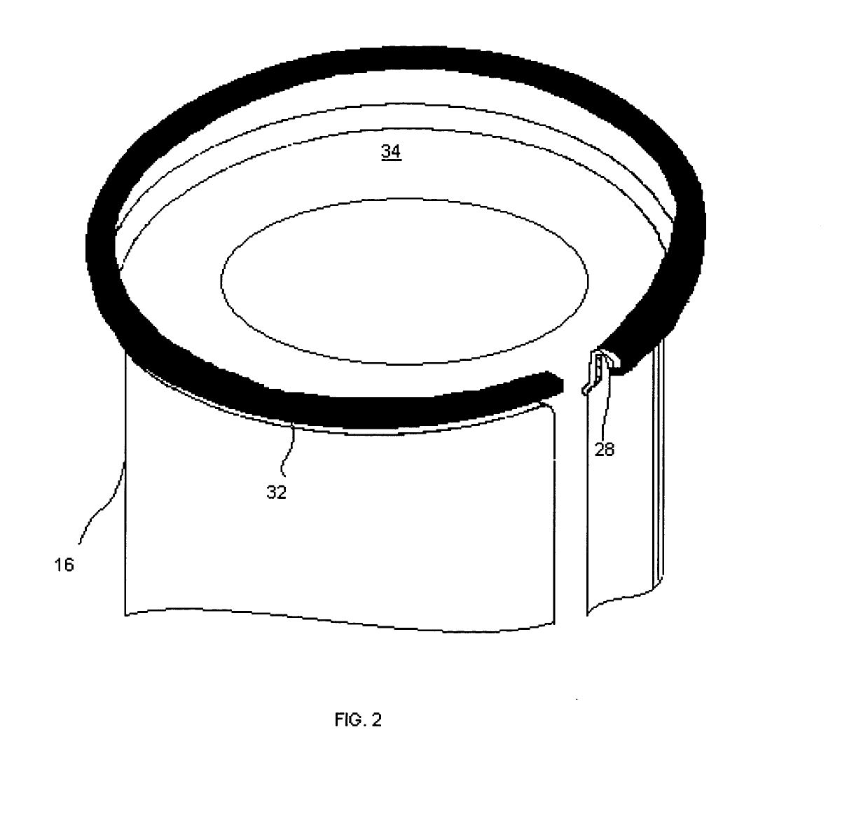

FIG. 2 is a perspective view of the filter inlet flange 18 with a cross section cut away to show the interior. Elastomer material 32 envelops the entire lip 28 of the inlet flange 18. The central area 34 of the inlet flange 18 is open to allow liquids to pass through it to the filter bag 16.

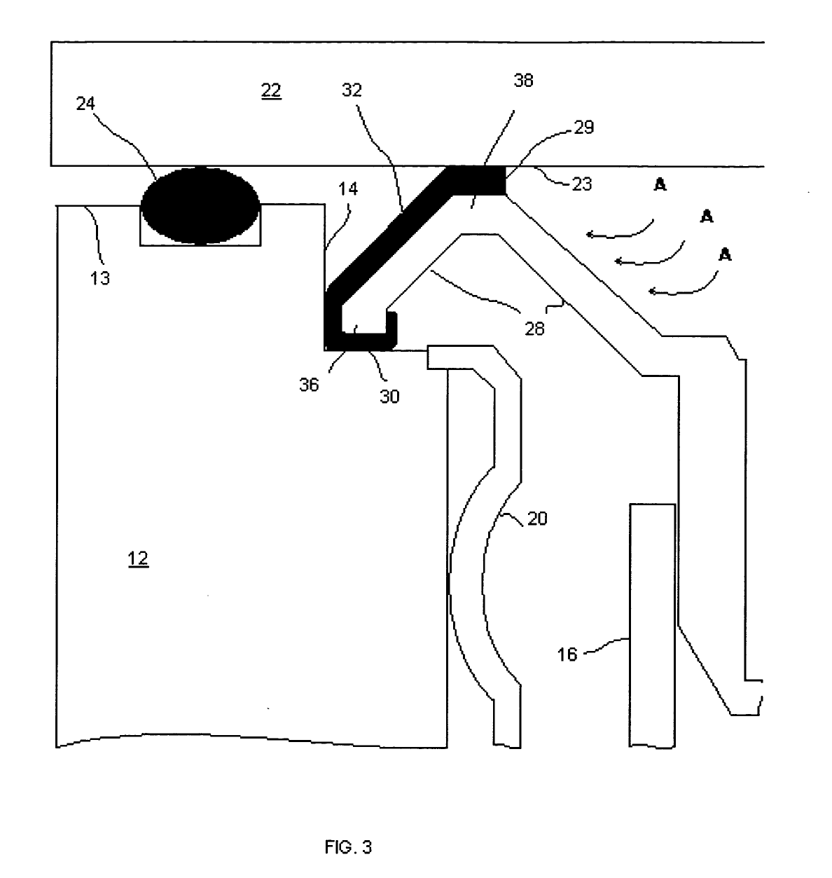

FIG. 3 illustrates further details of the lip 28 of the inlet flange 18 in accordance with one embodiment of the present invention. Lip 28 is formed as an inverted “V” with the tip 36 of the lip 28 resting on the internal surface edge 30 of the housing 12 in order to support the filter bag 16. The middle portion 38 of lip 28 extends above the upper surface 13 of the housing 12 and has a flat surface 29 that will contact the undersurface 23 of lid 22 when the lid 22 is closed over housing 12. An elastomer material 32 covers the flat surface 29 of middle portion 38 and tip area 36 in order to provide a positive seal between lip 28 and lid 22, and between lip 28 and the surface 30 of housing 12, respectively. In the embodiment shown in FIG. 3, the elastomer material 32 is molded onto or co-molded with the rigid plastic material forming lip 28 to make it an integral part of inlet flange 18.

Although the term elastomer is frequently used interchangeably with the term rubber, the term elastomer is formally defined (and is intended to be understood in this specification) as a high molecular weight polymer that can be, or has been modified, to a state exhibiting little plastic flow and rapid, nearly complete recovery from an extending or compressing force. In most instances, such material, before modification, is called unprocessed rubber.

When the basic high molecular weight polymer, without the addition of plasticizers or other dilutents, is converted by appropriate means to an essentially non-plastic state and tested at room temperature, it usually meets the following requirements in order to be called an elastomer:

A. It must not break when stretched approximately 100%.

B. After being held for five minutes at 100% stretch, it must retract to within 10% of its original length within five minutes of release

The American Society for Testing and Materials (ASTM) uses the above criteria to define the term elastomer. Extremely high hardness/modulus materials generally do not exhibit these properties even though they are still considered elastomers.

Thermoplastic elastomers are particularly well suited elastomers to use. These elastomers are capable of being injection molded, which makes this material ideal for a low cost assembly onto a thermoplastic inlet flange. For example, Santoprene, manufactured by Advanced Elastomer Systems, can be overmolded onto a polypropylene flange.

Upon closing the lid 22 onto the housing 12, the lid 22 will contact the elastomer material 32 at the middle portion 38 of the lip 28 and exert pressure on the lip 28 of the inlet flange 18. The pressure exerted on the lip 28 will compress the elastomer material 32 located at the middle and the tip 36 to create two leakproof seals: one between the lid 22 and the lip 28, and one between the lip 28 and the surface edge 30 of the housing 12.

In addition to the pressure from the lid 22, pressure against the lip 28 will be created by the volume of liquid that will enter the filter system. That internal pressure will be exerted against the lip 28 in an outward direction as depicted by arrows A. This internal pressure and the pressure from the lid 22 will also cause lip 28 to flex slightly such that the tip 36 will move against the vertical wall 14 of housing 12. The elastomer material 32 on the tip 36 contacting the vertical wall 14 will create an additional seal.

By using an inverted “V” shape with a flattened apex, this design provides for a parallel movement to accommodate variation in clearance between the lid and the seating portion of the vessel and a greater surface area to create a seal between the lid 22 and the lip 28.

The inverted “V” shape also facilitates the inclusion of the elastomer material 32 into the design. The elastomer material 32 can be added to the lip 28 of the inlet flange 18 by several different methods. The elastomer material 32 can be inserted by over-molding or insert molding wherein the inlet flange 18 is molded first and then the elastomer material 32 is molded onto the previously molded rigid component. The elastomer material 32 can also be molded onto the inlet flange 18 in the same mold in a two-shot or co-injection mold.

Molding the elastomer material 32 to be an integral part of the inlet flange 18 has advantages. First, filter bags are often replaced in a filter system with all other components remaining the same. Thus, a new seal is introduced with every new filter bag. Having a new elastomer material 32 with every filter bag ensures that the leakproof seal will not fail due to age or deterioration due to over-usage.

Another advantage is that making the elastomer material 32 integral with the inlet flange 18 prevents a leak occurring due to misalignment of a separate sealing gasket. Such misalignment can occur when internal pressures shift the sealing gasket along the undersurface of lid 22 to create a leak, or when the filter bag is replaced and the sealing gasket is incorrectly placed on the lip 28 of the inlet flange 18. Making the elastomer material 32 integral with the inlet flange 18 also eliminates the possibility of failing to replace a separate sealing gasket when replacing the filter bag in the filter system.

A further advantage is that the manufacturing process of molding the elastomer material 32 onto the inlet flange 18 is less expensive than creating a separate sealing gasket and assembling it onto the lip 28 of the inlet flange 18. That cost notwithstanding, it is within the scope of this invention to separately mold the sealing gasket and mechanically assemble it onto the lip 28 of the inlet flange 18. The nature of the inverted “V” design facilitates the process of providing an elastomer seal over the lip 28.

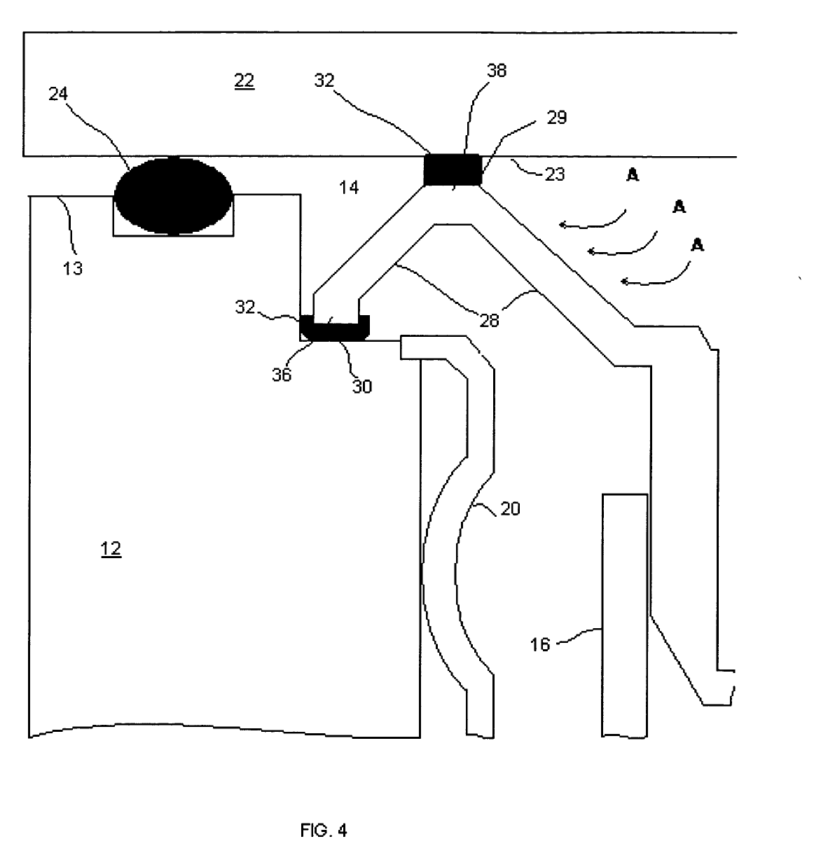

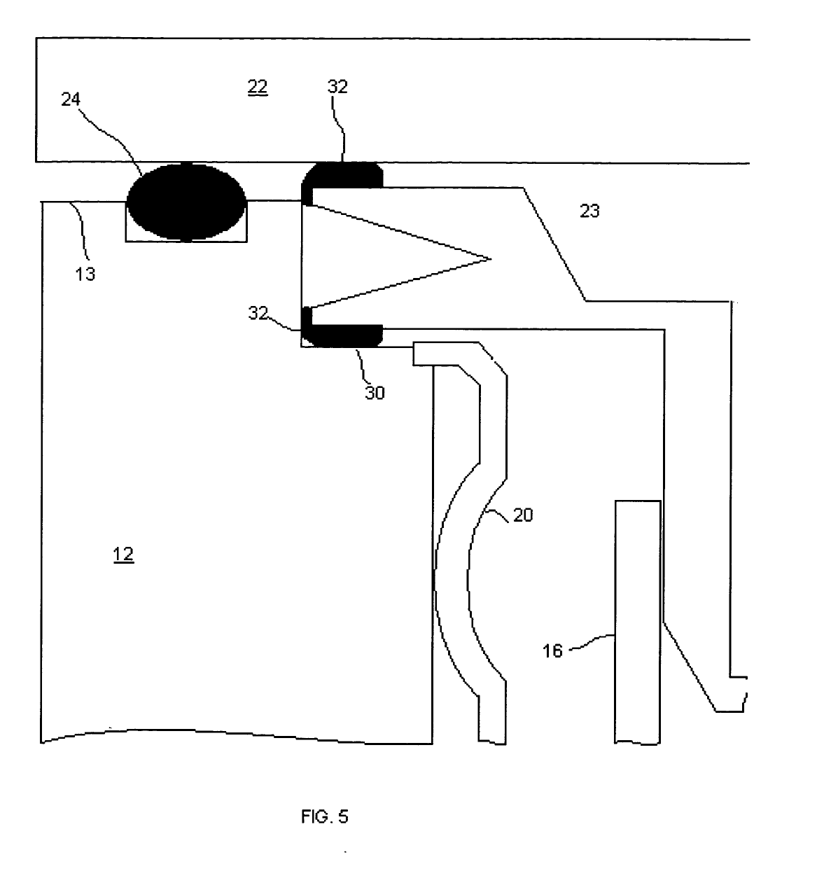

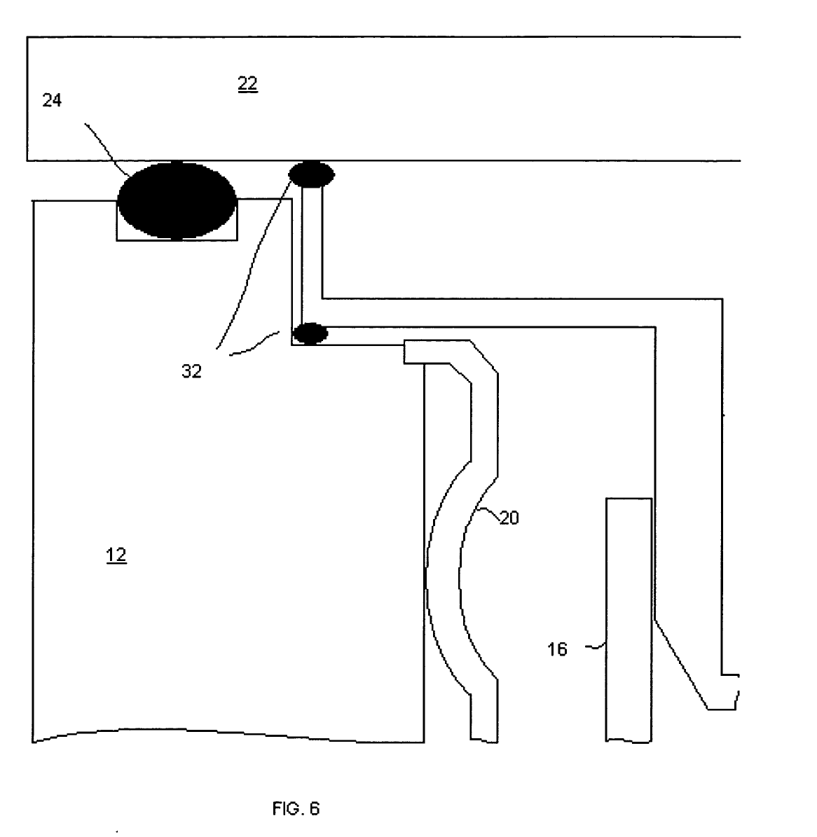

The invention is not limited to any particular shape of the lip 28 of the inlet flange 18, the shape of the elastomer material 32, or placement of the elastomer material 32 on the lip 28. FIGS. 4-6 depict various other designs incorporating an elastomer material 32 onto the lip 28 of the inlet flange 18 that are encompassed within the scope of the present invention.

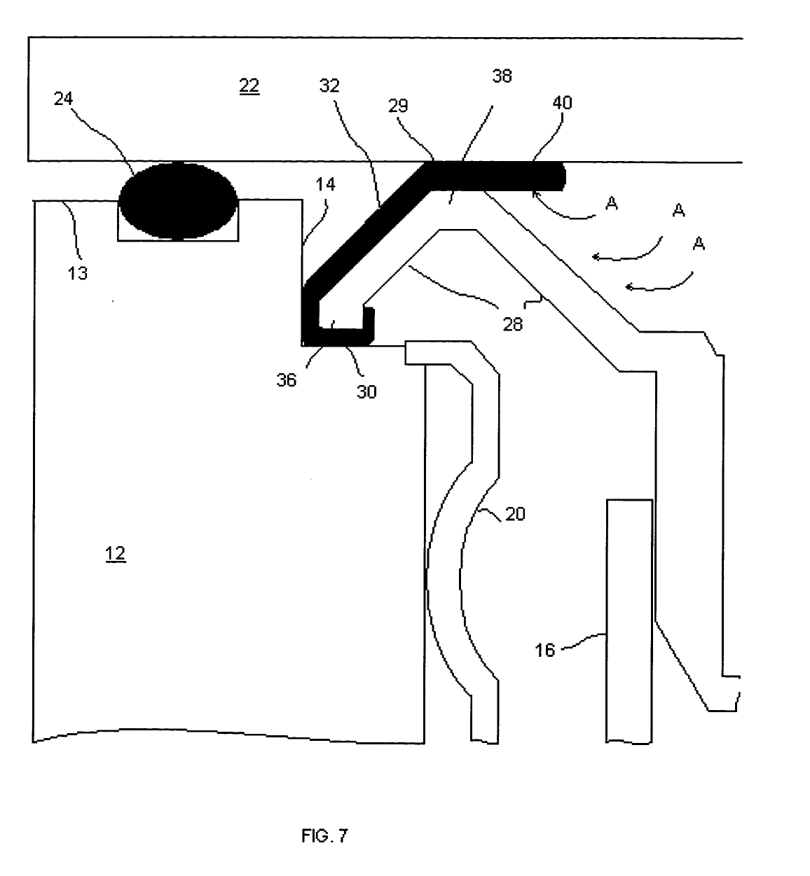

FIG. 7 depicts further details of the lip 28 of the inlet flange 18 in another embodiment of the invention. Lip 28 has an elastomer material 32 integrally formed at the tip 36 and middle portion 38 of the lip 28. In addition to those portions, the elastomer material 32 will have an extended portion 40 that extends from the middle portion 38 away from the lip 28 in a direction parallel to the lid 22 toward the central axis of the filter bag. When the lid 22 is placed in its closed position on housing 12, the extended portion 40 will remain in contact with the lid 22. As the volume of the liquid enters the filter system, the pressure differential will exert an increased force in the direction of arrows A. That force of the internal pressure will cause the extended portion 40 to be pressed against the lid 22 to create a leakproof pressure seal.

This design is advantageous because it utilizes the internal pressure and greater surface area of seal between the lid 22 and elastomer 32. In other designs, the internal pressure can work against any sealing mechanism by pushing against the sealing material to weaken the seal and potentially creating leaks. This design, however, creates a stronger seal as the internal pressure increase.

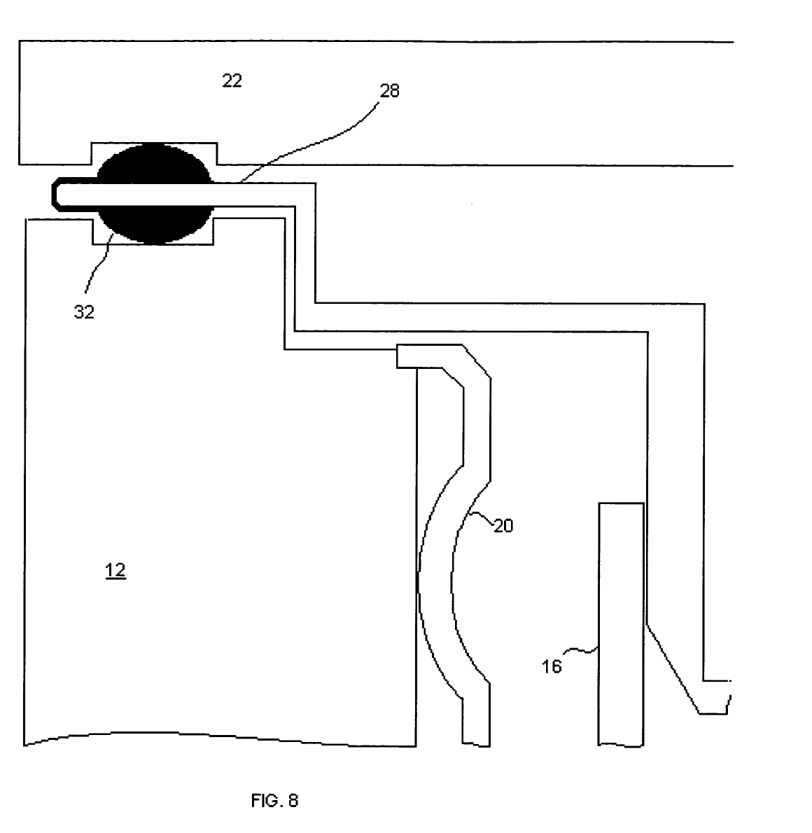

FIG. 8 depicts another embodiment of the present invention. In this design, lip 28 extends between the lid 22 and the housing 12. Elastomer material 32 is molded onto lip 28 at the locations where the lid 22 and housing 12 would contact the lip 28 respectively. When lid 22 covers housing 12, the elastomer material 32 will create two leakproof seals to prevent unfiltered liquids from commingling with the filtered liquids—one between the elastomer 32 and lid 22, the other between the elastomer 32 and the housing 12.

The major benefits of this new elastomeric seal design include:

only one seal is required for the complete system (filter element, basket and housing). Typically there are separate seals between the filter element to housing, and the housing lid to the housing. Sometimes, there are as many as three separate seals between the filter element to basket, basket to housing and lid to housing;

leakage from the unfiltered side would only be to the exterior of the housing and would never bypass to the filtered liquids in the housing;

enables a simple tri-clover style clamp design to be used for the housing closure to speed filter change-out.

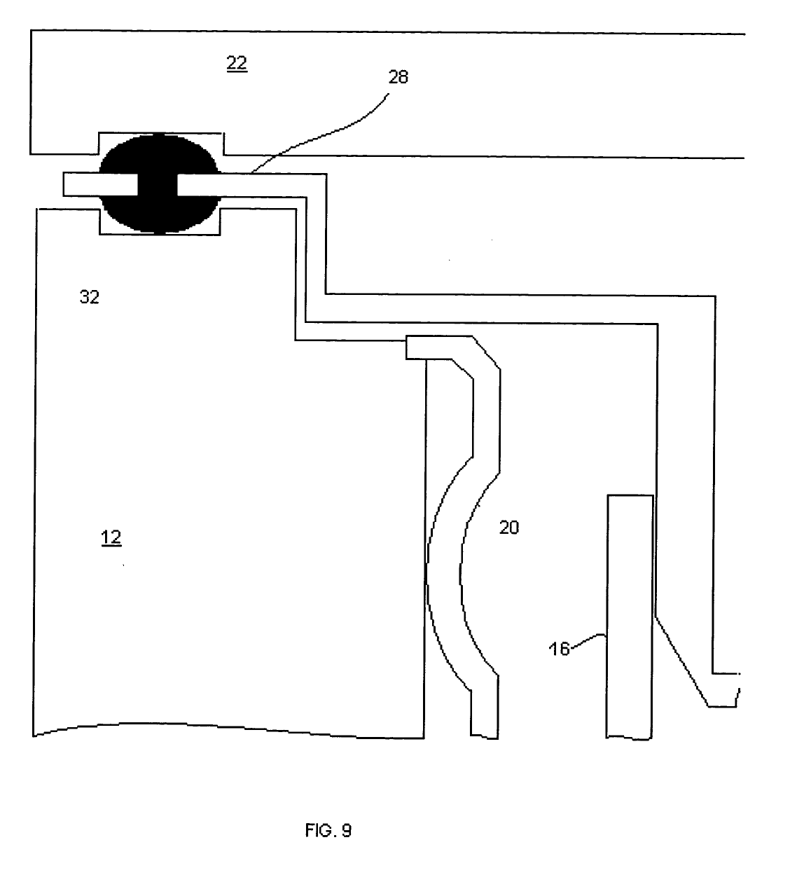

FIG. 9 depicts a variation on the embodiment illustrated in FIG. 8. Instead of having the elastomer material 32 envelop the tip 36 of the lip 28, the elastomer material 32 is located along the top and bottom of the lip 28 being connected to each other through intermittent holes in the lip 28.

The present invention is not to be considered limited in scope by the preferred embodiments described in the specification. Additional advantages and modifications, which readily occur to those skilled in the art from consideration and specification and practice of this invention are intended to be within the scope and spirit of the following claims:

We claim:

1. An inlet flange to be used in a filter system comprising:
a body capable of being attached to filter medium and allowing fluids to enter said filter medium;
a lip located on the edges of said body to enable said body to be supported in a filter housing; said lip comprising a first surface and a second surface; said first surface being capable of resting on a surface edge of the housing while said second surface extends above the housing; and
sealing material located at said first and second surfaces to prevent fluids from passing between said lip and the housing and between said lip and the lid.

2. The inlet flange as claimed in claim 1, wherein said sealing material is comprised of an elastomer material.

3. The inlet flange as claimed in claim 1, wherein said sealing material is comprised of a thermoplastic elastomer.

4. The inlet flange as claimed in claim 1, wherein said sealing material is an integral part of said lip.

5. The inlet flange as claimed in claim 1, wherein said sealing material is mechanically affixed to said lip.

6. The inlet flange as claimed in claim 1, wherein a portion of said sealing material extends from said second surface of said lip in a direction parallel to said lid such that said extended portion is capable of creating a seal against said lid due to internal pressure in the filtering system.

7. The filtering system as claimed in claim 1, wherein said sealing material will be compressed by the lid when the lid is covering the housing.

8. The filtering system as claimed in claim 1, wherein said sealing material will be compressed by the surface edge of the housing when the lid is covering the housing.

9. The inlet flange as claimed in claim 1, wherein said lip, said first surface and said second surfaces extend to be interposed between the lid and housing at the location where the lid and housing connect.

10. The inlet flange as claimed in claim 2, wherein said sealing material is an integral part of said lip.

11. The inlet flange as claimed in claim 2, wherein a portion of said sealing material extends from said second surface of said lip in a direction parallel to the lid such that said extended portion is capable of creating a pressure seal against the lid.

12. The inlet flange as claimed in claim 4, wherein a portion of said sealing material extends from said second surface of said lip in a direction parallel to the lid such that said extended portion is capable of creating a pressure seal against the lid.

13. The inlet flange as claimed in claim 1, wherein said body is circular in shape and said lip is located along the circumferential edges of said body.

14. An inlet flange for use in a filter system comprising:
a substantially rigid body, capable of attaching to a filter media;
a substantially rigid first lip portion located at the edges of said body; said first lip portion extending away from said body in an upward and outward direction;
a substantially rigid second lip portion located at the end of said first lip portion, said second lip portion extending away from said first lip portion in a downward and outward direction; and
sealing material located at the end of said first lip portion and the end of said second lip portion.

15. The inlet flange as claimed in claim 14, wherein said sealing material is comprised of an elastomer.

16. The inlet flange as claimed in claim 14, wherein said sealing material is comprised of a thermoplastic elastomer.

17. The inlet flange as claimed in claim 14, wherein said sealing material is mechanically affixed to said lip.

18. The inlet flange as claimed in claim 14, wherein said sealing material is an integral part of said first lip portion and said second lip portion.

19. The inlet flange as claimed in claim 14, wherein a portion of said sealing material extends away from the end of said first portion in an inwardly direction.

20. The inlet flange as claimed in claim 14, wherein the location where said second portion extends from said first portion comprises of a flat surface.

21. The inlet flange as claimed in claim 14, wherein said substantially rigid body is circular and said first lip portion is located at the circumferential edges of said body.

22. A filtering system comprising:
a housing;
a lid capable of being securely closed over said housing;
an inlet flange capable of supporting a filter media inside said housing; said flange having a lip on the edges of said flange; said lip being capable of resting on said housing while contacting said lid when securely closed over said housing;
sealing material located where said lip contacts said housing and said lid.

23. The filtering system as claimed in claim 22, wherein said seal is comprised of an elastomer.

24. The inlet flange as claimed in claim 22, wherein said sealing material is comprised of a thermoplastic elastomer.

25. The filtering system as claimed in claim 22, wherein said sealing material is an integral part of said lip.

26. The inlet flange as claimed in claim 22, wherein said sealing material is mechanically affixed to said lip.

27. The filtering system as claimed in claim 22, wherein said sealing material extends away from said lip in a direction parallel to said lid and in contact with said lid to create a pressure seal against said lid.

28. The filtering system as claimed in claim 22, wherein said lid exerts pressure on said lip when securely closed over said housing.
